(19) United States
(12) Patent Application Publication
(10) Pub. No.: US 2016/0237950 A1
(43) Pub. Date: Aug. 18, 2016

(54) BACKSIDE COATING COOLING PASSAGE

(71) Applicant: UNITED TECHNOLOGIES CORPORATION, Farmington, CT (US)

(72) Inventor: Steven W. Burd, Cheshire, CT (US)

(21) Appl. No.: 15/025,374

(22) PCT Filed: Aug. 5, 2014
(86) PCT No.: PCT/US2014/049759

§ 371 Date: Mar. 28, 2016

Related U.S. Application Data
(60) Provisional application No. 61/887,683, filed on Oct. 7, 2013.

(51) Int. Cl. F02K 1/82; F01D 25/30; F01D 25/12; F01D 5/18; F01D 9/02

(52) U.S. Cl. CPC F02K 1/822; F01D 5/18; F01D 9/02; F01D 25/12; F01D 25/30; F05D 2220/32; F05D 2230/90; F05D 2260/20; F05D 2250/90

(57) ABSTRACT

A component is provided for a gas turbine engine includes a substrate with an aperture. The component also includes a backside coating on a backside of the substrate and at least partially onto an inner boundary of the aperture, where the backside coating forms a passage with the aperture. A method of forming a shaped aperture in a component of a gas turbine engine is provided. The method includes applying a backside coating on a backside of a substrate and at least partially onto an inner boundary of an aperture. The backside coating forms a passage with the aperture including a convergent section, a divergent section and a throat therebetween.

### CROSS-REFERENCE TO RELATED APPLICATION

This application claims priority to U.S. Patent Application No. 61/887,683 filed Oct. 7, 2013, which is hereby incorporated herein by reference in its entirety.

### STATEMENT REGARDING FEDERALLY SPONSORED RESEARCH OR DEVELOPMENT

This disclosure was made with Government support under N00019-02-C-3003 awarded by the United States Air Force. The Government may have certain rights in this disclosure.

### BACKGROUND

The present disclosure relates to gas turbine engines, and more particularly to cooling arrangements therefor.

Gas turbine engines, such as those which power modern military and commercial aircraft, include a compressor section to pressurize a supply of air, a combustor section to burn a hydrocarbon fuel in the presence of the pressurized air, and a turbine section to extract energy from the resultant combustion gases to generate thrust. Downstream of the turbine section, military aircraft engines often include an augmentor section, or “afterburner” operable to selectively increase thrust. The increase in thrust is produced when fuel is injected into the core exhaust gases downstream of the turbine section and burned with the oxygen contained therein to generate a second combustion.

The augmentor section and downstream exhaust duct and nozzle sections may be exposed to high temperature exhaust gases. The exhaust gas temperatures may in some instances exceed the metal alloy capabilities in these sections such that a cooling flow is provided therefor. The cooling flow is provided though numerous cooling holes typically machined via a laser drill to sheath the hardware from the exhaust gases.

### SUMMARY

A component for a gas turbine engine, according to one disclosed non-limiting embodiment of the present disclosure, includes a substrate with an aperture. The gas turbine engine component also includes a backside coating on a backside of the substrate to form a shaped passage with the aperture.

In a further embodiment of the present disclosure, the shaped passage includes a convergent section, a divergent section and a throat therebetween.

In a further embodiment of any of the foregoing embodiments of the present disclosure, the divergent section is at least partially defined within the aperture.

In a further embodiment of any of the foregoing embodiments of the present disclosure, the backside coating is about as thick as the substrate.

In a further embodiment of any of the foregoing embodiments of the present disclosure, the backside coating forms a thickness between about 20%-100% of the inner boundary of the aperture.

In a further embodiment of any of the foregoing embodiments of the present disclosure, the inner boundary of the aperture is about 0.050-0.10 inches (1.27-2.54 mm) in characteristic diameter.

In a further embodiment of any of the foregoing embodiments of the present disclosure, the shaped passage includes a convergent section, a divergent section and a throat therebetween. The coating reduces the throat to about 10%-70% of the inner boundary of the aperture.

In a further embodiment of any of the foregoing embodiments of the present disclosure, the shaped passage includes a convergent section, a divergent section and a throat therebetween. The coating reduces the throat to about 50% of the inner boundary of the aperture.

In a further embodiment of any of the foregoing embodiments of the present disclosure, the shaped passage includes a convergent section, a divergent section and a throat therebetween. The throat is about 0.060 inches (1.5 mm) in characteristic diameter, the divergent section is about 0.090 inches (2.3 mm) in characteristic diameter.

In a further embodiment of any of the foregoing embodiments of the present disclosure, the backside coating is applied to the backside of the substrate as a spot.

In a further embodiment of any of the foregoing embodiments of the present disclosure, the component is a hot sheet of an exhaust duct.

A liner assembly for a gas turbine engine, according to another disclosed non-limiting embodiment of the present disclosure, includes a hot sheet with a multiple of apertures. The liner assembly also includes a backside coating on a backside of the hot sheet and at least partially onto an inner boundary of each of the multiple of apertures. The backside coating forms a passage with each of the multiple of apertures including a convergent section, a divergent section and a throat therebetween.

In a further embodiment of any of the foregoing embodiments of the present disclosure, a cold sheet is includes and spaced from the hot sheet, the backside coating faces the cold sheet.

In a further embodiment of any of the foregoing embodiments of the present disclosure, the backside coating defines a spot for each of the multiple of apertures.

A method of forming a shaped aperture in a component of a gas turbine engine, according to another disclosed non-limiting embodiment of the present disclosure, includes applying a backside coating on a backside of a substrate and at least partially onto an inner boundary of an aperture. The backside coating forms a passage with the aperture including a convergent section, a divergent section and a throat therebetween.

In a further embodiment of any of the foregoing embodiments of the present disclosure, the method includes locally applying the backside coating as a spot for each aperture.

In a further embodiment of any of the foregoing embodiments of the present disclosure, the method includes applying the backside coating to the entirety of the backside.

In a further embodiment of any of the foregoing embodiments of the present disclosure, the method includes reducing the throat to about 10%-70% of the inner boundary of the aperture.

In a further embodiment of any of the foregoing embodiments of the present disclosure, the method includes forming the aperture through the substrate prior to application of the backside coating.

In a further embodiment of any of the foregoing embodiments of the present disclosure, the method includes applying a coating on the front side of the substrate. The aperture is then formed through the substrate and the front side coating prior to application of the backside coating.

The foregoing features and elements may be combined in various combinations without exclusivity, unless expressly indicated otherwise. These features and elements as well as the operation thereof will become more apparent in light of the following description and the accompanying drawings. It should be understood, however, the following description and drawings are intended to be exemplary in nature and non-limiting.

### BRIEF DESCRIPTION OF THE DRAWINGS

Various features will become apparent to those skilled in the art from the following detailed description of the disclosed non-limiting embodiments. The drawings that accompany the detailed description can be briefly described as follows:

FIG. 1 is a general schematic view of an example gas turbine engine;

FIG. 2 is a perspective cross section of an example exhaust duct section of the engine;

FIG. 3 is a cross section through a passage according to one disclosed non-limiting embodiment;

FIG. 4 is a backside view showing a coating applied as a spot for each passage;

FIG. 5 is a flow chart of a coating application process;

FIG. 6 is a cross section through a substrate aperture prior to a coating application according to one non-limiting embodiment; and

FIG. 7 is a cross section through a substrate aperture prior to a coating application according to another non-limiting embodiment.

### DETAILED DESCRIPTION

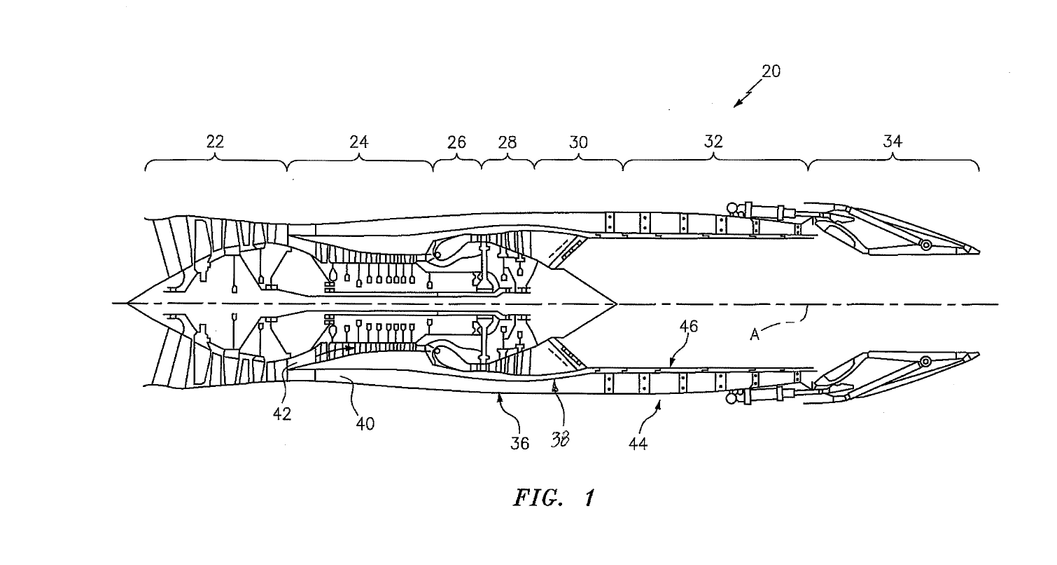

FIG. 1 schematically illustrates a gas turbine engine 20. The gas turbine engine 20 is disclosed herein as a two-spool low-bypass augmented turbofan that generally incorporates a fan section 22, a compressor section 24, a combustor section 26, a turbine section 28, an augmenter section 30, an exhaust duct section 32, and a nozzle section 34 along a central longitudinal engine axis A. Although depicted as an augmented low bypass turbofan in the disclosed non-limiting embodiment, it should be understood that the concepts described herein are applicable to other gas turbine engines including non-augmented engines, geared architecture engines, direct drive turbofans, turbojet, turboshaft, multi-stream variable cycle and other engine architectures.

An outer structure 36 and an inner structure 38 define a generally annular secondary airflow path 40 around a core primary airflow path 42. Various static structure and case modules may define the outer structure 36 and the inner structure 38 which essentially define an exoskeleton to support the rotational hardware therein.

Air that enters the fan section 22 is divided between a primary airflow through the primary airflow path 42 and a secondary airflow through the secondary airflow path 40. The primary airflow passes through the combustor section 26, the turbine section 28, then the augmentor section 30 where fuel may be selectively injected and burned to generate additional thrust through the nozzle section 34. It should be appreciated that additional airflow streams such as a third stream airflow typical of variable cycle engine architectures may additionally be provided.

The secondary airflow may be utilized for a multiple of purposes to include, for example, cooling and pressurization. The secondary airflow as defined herein as any airflow different from the primary airflow. The secondary airflow may ultimately be at least partially injected into the primary airflow path 42 adjacent to the exhaust duct section 32 and the nozzle section 34.

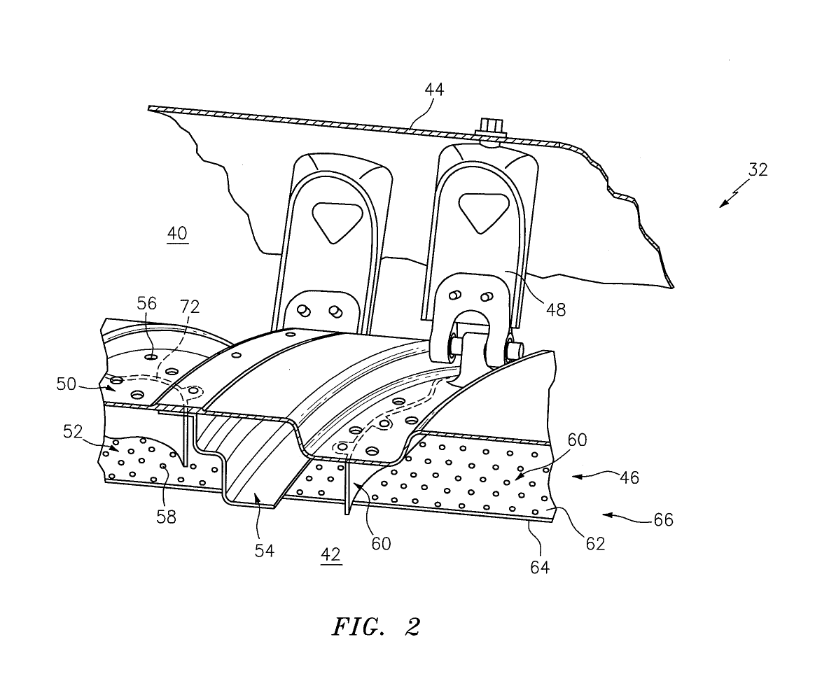

With reference to FIG. 2, the exhaust duct section 32 generally includes an outer exhaust duct case 44 (illustrated schematically) of the outer structure 36 and a liner assembly 46 spaced inward therefrom. The exhaust duct section 32 may be circular in cross-section as typical of an axis-symmetric augmented low bypass turbofan, non-axisymmetric in cross-section or combinations thereof. In addition to the various cross-sections, the exhaust duct section 32 may be non-linear with respect to the central longitudinal engine axis A to form, for example, a serpentine shape to block direct view to the turbine section 28. Furthermore, in addition to the various cross-sections and the various longitudinal shapes, the exhaust duct section 32 may terminate in the nozzle section 34 which may be a convergent divergent nozzle, a non-axisymmetric two-dimensional (2D) vectorable nozzle section, a flattened slot convergent nozzle of high aspect ratio or other exhaust duct arrangement.

The liner assembly 46 operates as a heat shield to protect the outer exhaust duct case 44 from the extremely hot combustion gases in the primary airflow path 42. Air discharged from, for example, the fan section 22 is communicated through the annular passageway 40 defined between the outer exhaust duct case 44 and the inner liner assembly 46. Since fan air and is relatively cool compared to the hot gases in the primary airflow path 42, the fan air cools the liner assembly 46 to enhance the life and reliability thereof.

The liner assembly 46 is mounted to the outer exhaust duct case via a multiple of hanger brackets 48. The liner assembly 46 generally includes a cold sheet 50 separated from a hot sheet 52 by a plurality of structural supports 54 which attach the cold sheet 50 to the hot sheet 52. During engine operation, the cold sheet 50 receives relatively large pressure loads and deflections, while the hot sheet 52 receives relatively small pressure loads and deflections and thereby better retains a heat resistant coating. It should be appreciated that various types of structural supports as well as locations therefor may be used herewith and that the illustrated structural supports 54 are but non-limiting examples.

The cold sheet 50 may be corrugated with various rippled or non-planar surfaces and include a multiple of metering passages 56 to receive secondary airflow from between the outer exhaust duct case 44 and the liner assembly 46. The secondary airflow is communicated through passages 58 in the hot sheet 52. The passages 58 provide effusion cooling and are generally more prevalent than the metering passages 56 which provide impingement cooling to the hot sheet 52. The secondary airflow thereby provides impingement and effusion cooling to sheath the liner assembly 46 from the relatively high temperature combustion products.

A backside 62 of the hot sheet 52 includes a backside coating 60 such as a thermal backside coating. A front side 64 of the hot sheet 52, opposite the backside 62, is a gas path side of the hot sheet 52 adjacent the relatively high temperature combustion products which, for example, may be generated by the secondary combustion of the augmenter section 30. Although the hot sheet 52 is illustrated herein as representative of a substrate 66 with the backside coating 60, it should be appreciated that various backside coated components will benefit herefrom to include, but not be limited to, airfoil components.

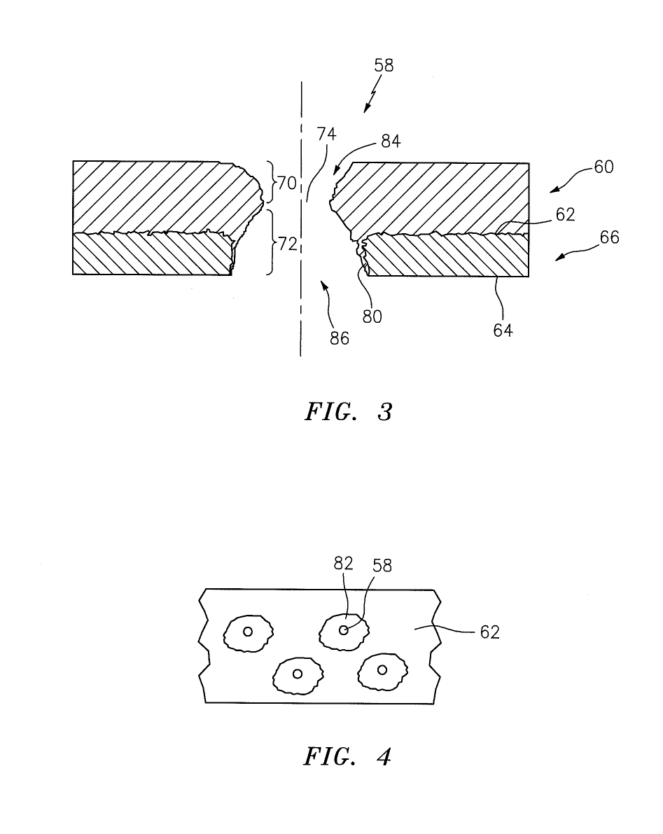

With reference to FIG. 3, each passage 58 in this disclosed non-limiting embodiment is a shaped cooling passage which is often alternatively referred to as a “diffusion”, “fanned” or “laid back” cooling passage. The passage 58 generally defines a convergent section 70, a divergent section 72 and a throat 74 therebetween. That is, the passage 58 is a “shaped” passage.

The passage 58 generally includes an aperture 80 formed into the substrate 66 which is with the backside coating 60 applied the backside 62 thereof. The aperture 80 may be, for example, drilled, cut, punched or otherwise formed through the substrate 66. Then the backside coating 60 is applied to the backside 62 of the substrate 66. The backside coating 60 may be applied via, for example, an air-plasma spray that partially passes through the aperture 80 to at least partially form the convergent section 70, the divergent section 72 and the throat 74. That is, as the backside coating 60 is applied on the backside 62 of the substrate 66, the backside coating 60 accumulates around the inner boundary 81 of the aperture 80.

In one example, the substrate 66 may be about equal in thickness to the backside coating 60 which may be about 0.2 inches (5 mm) thick. More specifically, the backside coating 60 may be 50%-200% the thickness of the substrate 66, and/or about 20%-100% of a characteristic diameter of the aperture 80. The aperture 80 in one disclosed non-limiting embodiment is about 0.050-0.10 inches (1.27-2.54 mm) in characteristic diameter. The term “characteristic diameter” as defined herein is applicable to circular and non-circular apertures such as an oval or racetrack shaped aperture 70. That is, the aperture 70 includes, but is not limited to, a circular cross section.

In one example, the throat 74 may be about 0.060 inches (1.5 mm) in characteristic diameter and the divergent section 72 may be about 0.090 inches (2.3 mm) in characteristic diameter. In another example, the backside coating 60 reduces the throat 74 to about 10%-70% and more particularly to about 50% of the inner boundary of the aperture 80.

The backside coating 60 may be applied to the entire backside 62, or, alternatively, the backside coating 60 need only be applied locally to the backside 62 at each aperture 80 to essentially form spots 82 of backside coating 60 on the backside 62 (FIG. 4). The application as spots 82 locally to each aperture 80 facilitates, for example, weight reduction.

The convergent section 70 forms an entrance 84 to the passage 58 and the throat 74 controls the cooling airflow through the passage 58. The divergent section 72 forms an exit 86 from the passage 58 to diffuse or fan the cooling air to facilitate airflow cooling of the substrate 66.

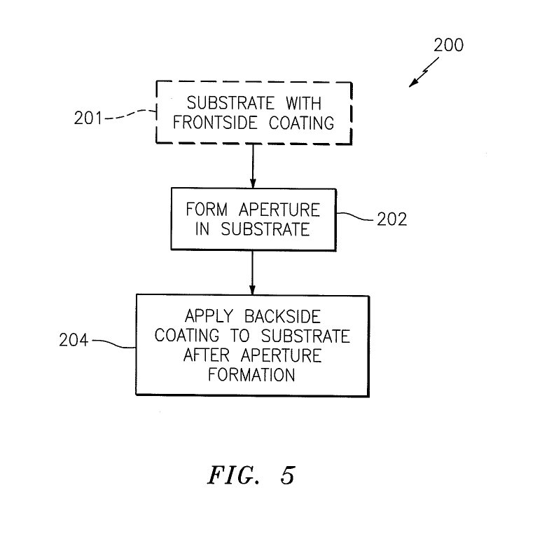

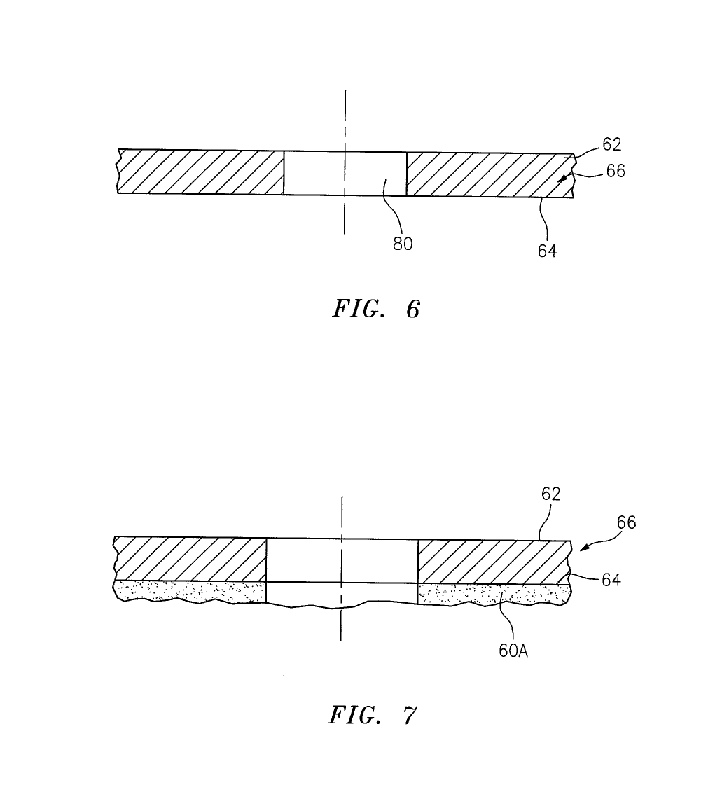

With reference to FIG. 5, a flow chart illustrates one disclosed non-limiting embodiment of a method 200 for fabricating the passage 58. The method 200 initially includes forming the aperture 80 in the substrate 66 (step 202; FIG. 6). The aperture 80 may be, for example, drilled, cut, punched or otherwise formed through the substrate 66. Optionally, the substrate 66 already includes a front side coating 60A on the front side 64 of the substrate 66 prior to fomiation of the aperture 80 (step 201; FIG. 7).

Next, the backside coating 60 is applied to the backside 62 of the substrate 66 (step 204). As the thickness of the backside coating increases through application, the backside coating 60 progressively reduces the through area of the aperture 80 to form the throat 74. The convergent section 70 to the passage 58 is thereby defined by the backside coating 60, which also defines the throat 74 and the divergent section 72. The size of the throat 74 is a function of, for example, the backside coating type, backside coating thickness, backside coating spray angle and shape of aperture 80. In general, the thickness accumulation of the backside coating 60 forms the throat 74, to readily form the hourglass type passage 58.

As application of the backside coating 60 forms the passage 58, manufacture thereof is relatively efficient and inexpensive compared to conventional passages.

The use of the teens “a” and “an” and “the” and similar references in the context of description (especially in the context of the following claims) are to be construed to cover both the singular and the plural, unless otherwise indicated herein or specifically contradicted by context. The modifier “about” used in connection with a quantity is inclusive of the stated value and has the meaning dictated by the context (e.g., it includes the degree of error associated with measurement of the particular quantity). All ranges disclosed herein are inclusive of the endpoints, and the endpoints are independently combinable with each other. It should be appreciated that relative positional terms such as “forward,” “aft,” “upper,” “lower,” “above,” “below,” and the like are with reference to the normal operational attitude of the vehicle and should not be considered otherwise limiting.

Although the different non-limiting embodiments have specific illustrated components, the embodiments of this invention are not limited to those particular combinations. It is possible to use some of the components or features from any of the non-limiting embodiments in combination with features or components from any of the other non-limiting embodiments.

It should be appreciated that like reference numerals identify corresponding or similar elements throughout the several drawings. It should also be appreciated that although a particular component arrangement is disclosed in the illustrated embodiment, other arrangements will benefit herefrom.

Although particular step sequences are shown, described, and claimed, it should be understood that steps may be performed in any order, separated or combined unless otherwise indicated and will still benefit from the present disclosure.

The foregoing description is exemplary rather than defined by the features within. Various non-limiting embodiments are disclosed herein, however, one of ordinary skill in the art would recognize that various modifications and variations in light of the above teachings will fall within the scope of the appended claims. It is therefore to be appreciated that within the scope of the appended claims, the disclosure may be practiced other than as specifically described. For that reason the appended claims should be studied to determine true scope and content.

What is claimed is:

1. A component for a gas turbine engine, the component comprising:
a substrate with an aperture; and
a backside coating on a backside of the substrate to form a shaped passage with the aperture.

2. The component as recited in claim 1, wherein the shaped passage includes a convergent section, a divergent section and a throat therebetween.

3. The component as recited in claim 2, wherein the divergent section is at least partially defined within the aperture.

4. The component as recited in claim 1, wherein the backside coating is about as thick as the substrate.

5. The component as recited in claim 1, wherein the backside coating forms a thickness between about 20%-100% of the inner boundary of the aperture.

6. The component as recited in claim 1, wherein the inner boundary of the aperture is about 0.050-0.10 inches (1.27-2.54 mm) in characteristic diameter.

7. The component as recited in claim 1, wherein the shaped passage includes a convergent section, a divergent section and a throat therebetween, and the coating reduces an area of the throat to about 10%-70% of the inner boundary of the aperture.

8. The component as recited in claim 1, wherein the shaped passage includes a convergent section, a divergent section and a throat therebetween, and the coating reduces the throat to about 50% of the inner boundary of the aperture.

9. The component as recited in claim 1, wherein the shaped passage includes a convergent section, a divergent section and a throat therebetween, the throat is about 0.060 inches (1.5 mm) in characteristic diameter, and the divergent section is about 0.090 inches (2.3 mm) in characteristic diameter.

10. The component as recited in claim 1, wherein the backside coating is applied to the backside of the substrate as a spot.

11. The component as recited in claim 1, wherein the component is a hot sheet of an exhaust duct.

12. A liner assembly for a gas turbine engine, the liner assembly comprising:
a hot sheet with a multiple of apertures; and
a backside coating on a backside of the hot sheet and at least partially onto an inner boundary of each of the multiple of apertures, the backside coating forming a passage with each of the multiple of apertures including a convergent section, a divergent section and a throat therebetween.

13. The liner assembly as recited in claim 12, further comprising a cold sheet spaced from the hot sheet, the backside coating faces the cold sheet.

14. The liner assembly as recited in claim 12, wherein the backside coating defines a spot for each of the multiple of apertures.

15. A method of forming a shaped aperture in a component of a gas turbine engine, the method comprising:
applying a backside coating on a backside of a substrate and at least partially onto an inner boundary of an aperture, the backside coating forming a passage with the aperture including a convergent section, a divergent section and a throat therebetween.

16. The method as recited in claim 15, further comprising locally applying the backside coating as a spot for each aperture.

17. The method as recited in claim 15, further comprising applying the backside coating to the entirety of the backside.

18. The method as recited in claim 15, further comprising reducing the throat to about 10%-70% of the inner boundary of the aperture.

19. The method as recited in claim 15, further comprising forming the aperture through the substrate prior to application of the backside coating.

20. The method as recited in claim 15, further comprising: applying a coating on a front side of the substrate, then forming the aperture through the substrate and the front side coating prior to application of the backside coating.
